(19) United States
(12) Patent Application Publication
(10) Pub. No.: US 2011/0261179 A1
(43) Pub. Date: Oct. 27, 2011

(54) IMAGING SYSTEM FOR FLUORESCENCE GUIDED SURGERY BASED ON FIXED MAGNIFICATION LENS AND DIGITAL ZOOM

(75) Inventor: Pavel A. Fomitchov, New York, NY (US)

(73) Assignee: General Electric Company

(21) Appl. No.: 12/765,204

(22) Filed: Apr. 22, 2010

(51) Int. Cl. H04N 7/18

(52) U.S. Cl. 348/77; 348/E07.085

(57) ABSTRACT

The invention relates to an imaging system for use in operating rooms and other applications. According to one example, the imaging system may include a visible light source configured to illuminate a surgical field with visible light and an excitation source configured to generate excitation light to excite a fluorescent substance in an organism within the surgical field. The imaging system may also include an imaging lens system including a first sensor configured to receive visible light reflected from the surgical field via a first spectral channel and a second sensor configured to receive a fluorescent emission emitted from the fluorescent substance in the organism via a second spectral channel. The imaging system may further include a plurality of fixed magnification lenses configured to optically couple image signals to the first sensor and the second sensor, and a control unit configured to receive and digitally process the image signals to generate a plurality of image frames in order to rescale the plurality of image frames for display to a surgeon.

### FIELD OF THE INVENTION

The present invention relates generally to medical imaging and more particularly to image processing systems and methods for surgical and other applications.

### BACKGROUND

Various medical imaging systems and methods have been developed to assist surgeons in performing surgical procedures. For example, fluorescence guided surgical imaging systems allow surgeons to see anatomy and fluorescence-marked body areas simultaneously, with high spatial resolution, and in real time. Fluorescence guided surgical imaging technology is based on the use of fluorescent dyes that are injected into human tissue to visualize specific areas of the body, such as blood vessels, tumors, the urinal tract, etc. Fluorescence guided surgical imaging technology can provide relatively deep imaging depth into body tissue, minimal autofluorescence, reduced scatter, and high optical contrast. The images provided by a fluorescence guided surgical imaging system may be displayed on one or more display devices in an operating room for visual guidance for the surgeon.

Known fluorescence guided surgical imaging systems utilize a single optical system (e.g., a continuously variable zoom lens imaging system) providing a single optical path to form an image of the surgical field of view. The continuously variable zoom lens imaging systems adjust to change a size of a field of view. For example, the continuously variable zoom lens may be adjusted to have a low magnification (e.g., a large size of field of view) or a high magnification (e.g., a small size of field of view). However, known continuously variable zoom lens imaging systems have some limitations. For example, known continuously variable zoom lens imaging systems have significant amount of chromatic aberration when changing the zoom setting and may lead to blurring of the near-infrared range fluorescent images (e.g., near-infrared range fluorescent images remain in focus only for limited settings of the continuously variable zoom lens imaging system). Also, known continuously variable zoom lens imaging systems introduce geometric distortion into images (e.g., 2%-5%). Further, known continuously variable zoom lens imaging systems having extended spectral range is only available in limited custom designed imaging systems which leads to high price increase.

The present invention addresses these and other limitations of known fluorescence guided surgical imaging systems.

### SUMMARY

The invention relates to a fluorescence guided surgical imaging system for providing images of an organism or other subject. According to one example, the fluorescent guided surgical imaging system may include a visible light source configured to illuminate a surgical field with visible light and an excitation source configured to generate excitation light to excite a fluorescent substance in an organism within the surgical field. The fluorescent guided surgical imaging system may also include an imaging lens system including a first sensor configured to receive visible light reflected from the surgical field via a first spectral channel and a second sensor configured to receive a fluorescent emission emitted from the fluorescent substance in the organism via a second spectral channel. The fluorescent guided surgical imaging system may further include a plurality of fixed magnification lenses configured to optically couple image signals to the first sensor and the second sensor, and a control unit configured to receive and digitally process the image signals to generate a plurality of image frames in order to rescale the plurality of image frames for display to a surgeon.

For example, the fluorescence guided surgical imaging system may comprise a fixed magnification lens imaging system having a plurality of fixed magnification lenses to adjust optical magnification and a size of the field of view. In an exemplary embodiment, a fixed magnification lens imaging system may have a plurality of fixed magnification lenses each having different optical magnification to acquire the field of view of different size. For example, the first fixed magnification lens may have 1× optical magnification, the second fixed magnification lens may have 2× optical magnification, the third fixed magnification lens may have 3× optical magnification, and the fourth fixed magnification lens may have 4× optical magnification, and etc. The fixed magnification lens imaging system may also comprise a motion controller that control the position of the plurality of fixed magnification lenses to adjust optical magnification and a size of the field of view. The fluorescent guided surgical imaging system may combine the fixed magnification lens imaging system and digital processing (e.g., resize or crop) in order to provide an image (e.g., eliminating upsampling of images) to a user.

Also, the fluorescent guided surgical imaging system comprises a visible (e.g., color or black and white) imaging optics system configured to receive images from a visible spectral channel and fluorescent imaging optics system configured to receive images from a fluorescent spectral channel. The visible imaging optics system may include a visible filter, and/or a visible relay lens optically coupled to a visible image sensor configured to receive image information from an organism or other subject and may convert the image information into an image signal to be displayed on a display. The fluorescent imaging optics system may include a fluorescent filter, and/or a fluorescent relay lens optically coupled to a fluorescent image sensor configured to receive image information from an organism or other subject and may convert the image information into an image signal. The fluorescence guided surgical imaging system may also comprise one or more dichroic mirrors or dichroic filters configured to allow the fluorescent image information to pass while reflecting the visible image information. The fluorescence guided surgical imaging system may further comprise a mirror configured to redirect an optical path of the image information from the organism.

The fluorescence guided surgical imaging system may comprise a control unit coupled to a display device, such as a computer control workstation, that receives the respective image signals from the visible imaging optics system and the fluorescent imaging optics system. The control unit may comprise a processor programmed to control the operation of the fluorescence guided surgical imaging system and to generate a plurality of image frames for transmission to a display device or to a video interface designed to transmit the plurality of image frames to the display device. The control unit may process the image information received from the visible imaging optics system and the fluorescent imaging optics system based at least in part on an optical magnification. For example, the control unit may down-sample the image information received from the visible imaging optics system and the fluorescent imaging optics system in order to be display via the display device.

The fluorescence guided surgical imaging system may comprise a visible light source that may be configured to illuminate a surgical field with visible light to generate a first image, and a fluorescent excitation light source that may be configured to generate light to excite a fluorescent substance in an organism within the surgical field to generate a second image. The fluorescence guided surgical imaging system may also comprise a plurality of imaging sensors that may receive the first image and the second image from the surgical field via a plurality of spectral channels including, for example, an imaging lens system including a fixed magnification lens imaging system having a plurality of fixed magnification lenses to adjust optical magnification and a size of the field of view, that optically couple the surgical field to the plurality of imaging sensors. The fluorescent guided surgical imaging system may further comprise a control unit configured to receive image signals from the first sensor and the second sensor and to generate a plurality of image frames.

### BRIEF DESCRIPTION OF THE DRAWINGS

These and other features and aspects of exemplary embodiments of the invention will become better understood when reading the following detailed description with reference to the accompanying drawings, in which like reference numbers represent like parts throughout the drawings, and wherein:

FIG. 1 is a diagram of a fluorescence guided surgical imaging system having multiple fixed magnification lenses according to an exemplary embodiment of the present disclosure;

While the drawings illustrate system components in a designated physical relation to one another or having a designated electrical communication with one another, and process steps in a particular sequence, such drawings illustrate examples of the invention and may vary while remaining within the scope of the invention.

### DETAILED DESCRIPTION

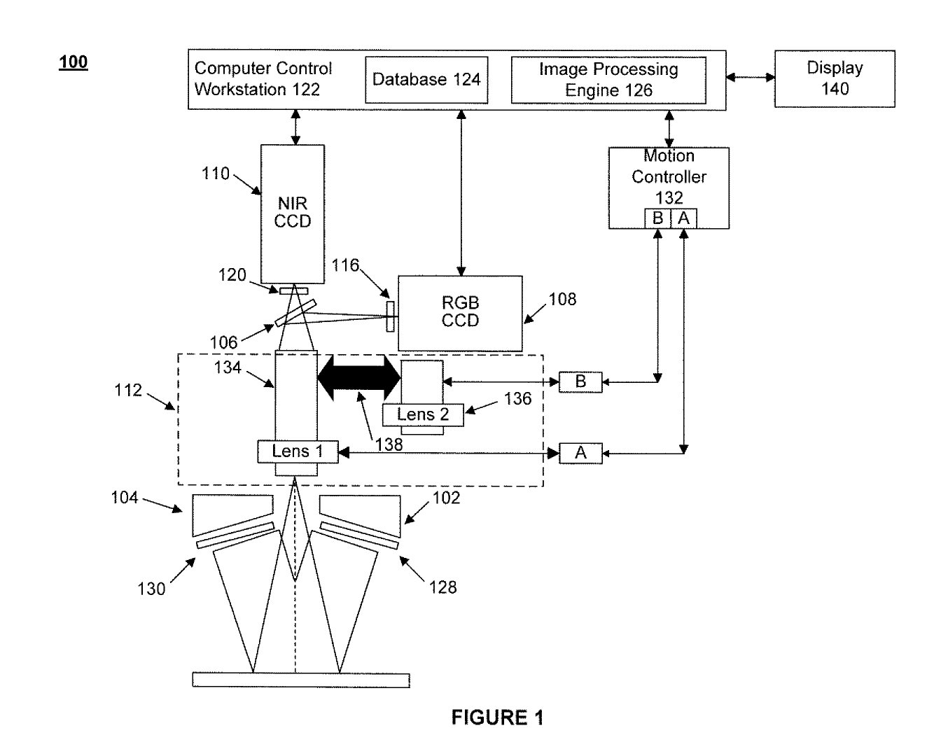

A fluorescence guided surgical imaging system, according to one embodiment of the invention, is shown in FIG. 1. The fluorescence guided surgical imaging system illustrated in FIG. 1 may utilize a fluorescent contrast agent to illuminate various vessels or tissues in an organism for surgical guidance, complication reduction, and treatment verification. The fluorescence guided surgical imaging system 100 may include a visible (e.g., red/green/blue color and/or black and white) optical spectral channel. The fluorescence guided surgical imaging system 100 may also include one or more fluorescent optical spectral channels with one or more excitation sources and one or more fluorescent emissions. However, as will be described below, other embodiments of the invention may utilize different configurations of the fluorescence guided surgical imaging system and the following detailed description of the system in FIG. 1 is merely one example of an embodiment of the invention.

As shown in FIG. 1, the fluorescence guided surgical imaging system 100 may comprise a white light source 102 and an excitation source 104 to simultaneously illuminate a surgical field with visible light and excitation light, respectively. The excitation light may comprise near-infrared (NIR) or infrared (IR) light, for example, although other wavelengths may also be used. The white light source 102 and the excitation source 104 may be mounted on either side of the surgical field, using articulating arms in order to sufficiently illuminate the surgical field. The white light source 102 and the excitation source 104 may have optical filters 128 and 130, respectively, in order to illuminate a surgical field with filtered light of desired wavelength. The fluorescence guided surgical imaging system 100 may also comprise a dichroic mirror 106 that optically couples a visible image sensor 108 and a fluorescent image sensor 110 to the surgical field. The fluorescent guided surgical imaging system 100 may further comprise an imaging system 112 comprising a plurality of fixed magnification lenses (e.g., a first fixed magnification lens 134 and a second fixed magnification lens 136) and a motorized turret 138 to adjust optical magnification and a size of the field of view. Also, the imaging system 112 may comprise a focus lens (not shown) and/or an optical aperture (not shown) in order to adjust the position of the focal plane, size of the optical aperture and depth of field. In an exemplary embodiment, the plurality of fixed magnification lenses (e.g., a first fixed magnification lens 134 and a second fixed magnification lens 136) may be mounted on the motorized turret 138 that may rotate different fixed magnification lenses in and out of an optical path to receive image information from a field of view.

According to an embodiment of the present disclosure, imaging system 112 may include a plurality of fixed magnification lenses (e.g., a first fixed magnification lens 134 and a second fixed magnification lens 136) to adjust optical magnification and a size of the field of view. Each of the plurality of fixed magnification lenses may have a different optical magnification in order to adjust the size of a field of view. The number of fixed magnification lenses of the imaging system 112 may be based at least in part on a number of optical magnifications (e.g., 1×, 2×, 3×, 4×, 5×, etc). In an exemplary embodiment, the imaging system 112 may include at least two fixed magnification lenses (e.g., a first fixed magnification lens 134 and a second fixed magnification lens 136) to adjust optical magnification and a size of the field of view. The first fixed magnification lens 134 may have a 1× optical magnification and the second fixed magnification lens 136 may have a 2× optical magnification. For example, a field of view with size may range from 25×25 mm to 100×100 mm, 1× optical magnification may have a size of 100×100 mm for the field of view and 2× optical magnification may have a size of 25×25 mm for the field of view.

The fluorescence guided surgical imaging system 100 may include a motion controller 132 coupled to the computer control workstation 122. The motion controller 132 may include a plurality of lines (e.g., line A, line B) to provide one or more control signals to a plurality of actuators (e.g., actuator A, actuator B) to adjust the plurality of fixed magnification lens (e.g., a first fixed magnification lens 134 and a second fixed magnification lens 136) of the imaging system 112. In an exemplary embodiment, the actuator A may rotate the first fixed magnification lens 134 of the imaging system 112 in and out of the optical path to receive image information from a field of view in order to adjust an optical magnification and the size of a field of view. Also, the actuator B may rotate the second fixed magnification lens 136 of the imaging system 112 in and out of the optical path to receive image information from a field of view in order to adjust an optical magnification and the size of a field of view. The plurality of actuators may include a motor, such as a DC motor or AC motor, a piezo-actuator, and/or other mechanical device for moving or controlling the lenses and aperture. The plurality of actuators may be coupled to the imaging system 112 via one or more mechanical or electro-mechanical links. For example, the one or more mechanical links may comprise gears, belts, and/or other devices for coupling the movements of an actuator.

The fluorescence guided surgical imaging system 100 may further comprise a visible imaging optics system having a visible filter 116 located between the visible image sensor 108 and the surgical field. Also, the visible imaging optics system may comprise a visible relay lens system (not shown) located between the visible filter 116 and the visible image sensor 108. In addition, a fluorescent imaging optics system having a fluorescent filter 120 may be provided for the fluorescent image sensor 110. Also, the fluorescent guided surgical imaging system 100 may comprise a fluorescent relay lens system (not shown) located between the fluorescent filter 120 and the fluorescent image sensor 110. The visible image sensor 108 and the fluorescent image sensor 110 may receive image information from the visible optical spectral channel and the fluorescent optical spectral channel, respectively, and may convert the image information into an image signal. The visible image sensor 108 and the fluorescent image sensor 110 may be referred to as “detectors” and may be digital or analog, for example. The image signal from the visible image sensor 108 and the fluorescent image sensor 110 may be transmitted to the computer control workstation 122. The computer control workstation 122 may transmit the image signal to the display device 140 to be viewed by a user (e.g., a surgeon).

The white light source 102, according to an exemplary embodiment of the invention, may comprise a light source adapted to illuminate the organism in the surgical field with a desired range of wavelengths. For example, the white light source 102 may comprise an incandescent, halogen, or fluorescence light source, and/or other light source to generate the desired range of wavelengths. In other exemplary embodiments, the white light source 102 may comprise a xenon light source, a metal halide light source, a mercury light source, and/or any light source that sufficiently illuminates the surgical field. The white light source 102 may comprise a multitude of light sources and/or a combination of light sources, such as arrays of light emitting diodes (LEDs), lasers, laser diodes, lamps of various kinds, or other known light sources. According to one example, the white light source 102 includes one or more filters to filter out any undesired wavelengths in order to illuminate the surgical field with desired range of wavelengths of light (e.g., blocking wavelengths that are in the near-infrared (NIR) range or infrared (IR) range). In an exemplary embodiment, the white light source 102 may comprise a halogen lamp having a hot mirror located inside the white light source 102 such that the reflective surface of the hot mirror may be oriented toward the halogen lamp. The white light source 102 may also include a heat filter and a second hot mirror in order to direct the light towards the surgical field.

The excitation source 104 may be any source that emits an excitation wavelength or wavelength range capable of causing a fluorescent emission from a fluorescent substance in the organism. For example, the excitation source 104 may include light sources that use a halogen lamp, light emitting diodes, laser diodes, laser dyes, lamps, and the like. Also, the excitation source 104 may comprise a multitude of light sources and/or a combination of light sources, such as arrays of light emitting diodes (LEDs), lasers, laser diodes, lamps of various kinds, or other known light sources. In other exemplary embodiments, the excitation source 104 may be a xenon light source, a metal halide light source, a mercury light source, or any light source that sufficiently excites the fluorescent substance in the subject. In an exemplary embodiment, the excitation source 104 may be a halogen light source having one or more filters to filter out undesired wavelengths in order to illuminate the surgical field with the desired wavelengths of light (e.g., passing 725 nm−775 nm light). Also, the excitation source 104 may include one or more bandpass filters in order to achieve the desired wavelength of light. The excitation source 104 may be configured to generate a wavelength or wavelength range within and/or outside of the visible wavelengths.

During surgery, the surgeon may position the white light source 102 to illuminate a desired surgical site and to acquire reflectance images (i.e., images comprised of light reflected from the organism). The surgeon may position the excitation source 104 to excite a fluorescent contrast agent in the organism and to acquire fluorescent images of the organism. The visible image sensor 108 and the fluorescent image sensor 110 may be used to acquire image information used to generate a merged image in which a fluorescence image is superimposed on a reflectance image. The merged image may assist the surgeon in visualizing the area to be treated and in discriminating certain tissues and vessels during surgery. The imaging system 112 may have a plurality of fixed magnification lenses (e.g., a first fixed magnification lens 134 and a second fixed magnification lens 136) and the motorized turret 138 in order to adjust an optical magnification and the size of a field of view. Examples of methods for creating such a merged image are disclosed, for example, in U.S. Application No. 61/039,038, filed Mar. 24, 2008, entitled “Image Processing Systems and Methods for Surgical Applications,” and U.S. application Ser. No. 12/054,214, filed Mar. 24, 2008, entitled “Systems and Methods for Optical Imaging,” both of which are hereby incorporated by reference in their entireties.

Examples of fluorescent contrast agents are known in the art and are described, for example, in U.S. Pat. No. 6,436,682 entitled “Luciferases, fluorescent proteins, nucleic acids encoding the luciferases and fluorescent proteins and the use thereof in diagnostics, high throughput screening and novelty items”; P. Varghese et al., “Methylene Blue Dye—A Safe and Effective Alternative for Sentinel Lymph Node Localization,” Breast J. 2008 January-February; 141:61-7, PMID: 18186867 PubMed—indexed for MEDLINE; F. Aydogan et al., “A Comparison of the Adverse Reactions Associated with Isosulfan Blue Versus Methylene Blue Dye in Sentinel Lymph Node Biopsy for Breast Cancer,” Am. J. Surg. 2008 February; 1952:277-8, PMID: 18194680 PubMed—indexed for MEDLINE; and as commercially available products such as Isosulfan Blue or Methylene Blue for tissue and organ staining.

The dichroic mirror 106 may divide or split the light reflected from the surgical field into the visible optical spectral channel for the visible image sensor 108 and the fluorescent optical spectral channel for the fluorescent image sensor 110. In another exemplary embodiment, the dichotic mirror 106 may be a beam splitter in order to split the light reflected from the surgical field into the visible optical spectral channel and the fluorescent optical spectral channel. As illustrated in FIG. 1, the dichroic mirror 106 may reflect the image information from the visible optical spectral channel to the visible image sensor 108 while passing the image information from the fluorescent optical spectral channel to the fluorescent image sensor 110. In an exemplary embodiment, the dichroic mirror 106 may reflect the visible light in the visible optical spectral channel to the visible image sensor 108 through the visible filter 116 and the visible relay lens system (not shown). Also, the dichroic mirror 106 may pass the fluorescent light in the fluorescent optical spectral channel to the fluorescent image sensor 110 via the fluorescent filter 120, and/or the fluorescent relay lens system (not shown). Also, the type of dichroic mirror 106 may be dependent upon the type of fluorescent contrast agent injected into various vessels or tissues of the organism.

The visible image sensor 108 and the fluorescent image sensor 110 may comprise any device configured to receive image data, such as a charge coupled device (CCD) camera, a photo detector, a complementary metal-oxide semiconductor (CMOS) camera, and the like. The visible image sensor 108 and the fluorescent image sensor 110 may comprise an analog or a digital image sensor. The visible image sensor 108 and the fluorescent image sensor 110 may receive the visible light and the fluorescence emission and may convert them to signals that are transmitted to an image processing engine 126 in the computer control workstation 122 to be displayed via the display device 140. Also, the visible image sensor 108 and the fluorescent image sensor 110 may have independent optical spectral filters to optimize the signal to noise ratio. In an exemplary embodiment, the visible image sensor 108 may comprise a charged coupled device (CCD) image sensor configured to receive image information from the visible optical spectral channel and to convert the image information into an image signal. The fluorescent image sensor 110 may be a charged coupled device (CCD) image sensor configured to receive image information from the fluorescent optical spectral channel and to convert the image information into an image signal. Also, the visible image sensor 108 and/or the fluorescent image sensor 110 may operate in one or more modes. For example, the visible image sensor 108 and/or the fluorescent image sensor 110 may operate in a free running mode where a display is refreshed at a rate set by the visible image sensor 108 and/or the fluorescent image sensor 110. The visible image sensor 108 and/or the fluorescent image sensor 110 may operate in a snap acquire mode where the image information received by the visible image sensor 108 and the fluorescent image sensor 110 are merged and saved to a hard disk. The visible image sensor 108 and/or the fluorescent image sensor 110 may operate in a free acquire mode where a continuous time lapse of image information received by the visible image sensor 108 and/or the fluorescent image sensor 110 are saved to a hard disk.

As discussed above, the dichroic mirror 106 may divide the image information into different paths or channels either spectrally or by splitting the image with a partially reflective surface. For example, the dichroic mirror 106 may divide the fluorescence emission from the reflected light. The fluorescence emission may travel through the fluorescent filter 120 and then be focused onto the fluorescent image sensor 110. The fluorescent filter 120 may be configured to reject the reflected visible light and the excitation light from being detected by the fluorescent image sensor 110, while allowing the fluorescent emission from the fluorescent substance in the organism to be detected by the fluorescent image sensor 110. The visible filter 116 may ensure that the excitation light and fluorescence emission are rejected from detection to allow for accurate representation of the visible reflected light image. The visible filter 116 and/or the fluorescent filter 120 may each comprise a short pass filter, a bandpass filter, and/or other filters that may have a sharp transition at each cutoff point in order to filter the respective desired wavelengths of light.

The visible filter 116 and/or the visible relay lens system (not shown) are components of a visible imaging optics system for receiving image information via the visible optical spectral channel, according to an exemplary embodiment of the invention. The fluorescent filter 120 and/or the fluorescent relay lens system (not shown) are components of a separate fluorescent optics system for receiving image information via the fluorescent optical spectral channel. Each optics system associated with the visible optical spectral channel and the fluorescent optical spectral channel, respectively, may allow for adjustment of the motorized turret 138 of the plurality of fixed magnification lenses (e.g., a first fixed magnification lens 134 and a second fixed magnification lens 136) of the imaging system 112.

As discussed above, the visible image sensor 108 and the fluorescent image sensor 110 may be electrically coupled to the computer control workstation 122. The computer control workstation 122 may display visible images and/or fluorescent images via the display device 140. The motion controller 132 may be electrically coupled to the computer control workstation 122. The computer control workstation 122 may include one or more databases 124 in order to receive image information from the visible optical spectral channel and the fluorescent optical spectral channel. The computer control workstation 122 may also include one or more control software programs that may process (e.g., sampling data compression, or data expansion) the imaging signals. In an exemplary embodiment, the computer control workstation 122 may provide a number of functions, additional features or components, such as power conditioning, user interface(s) (such as a mouse, touch screen, display device, foot pedals, keyboard, voice inputs, etc.), network interface(s) (e.g., DICOM, networking, archiving, printing, etc.), and an interface to one or more video display devices. The computer control workstation 122 may display the image information received from the visible optical spectral channel and the fluorescent optical spectral channel on separate display devices 140. Also, the computer control workstation 122 may display the image information received from the visible optical spectral channel and the fluorescent optical spectral channel on a single display device 140. The computer control workstation 122 may also provide image processing and data storage functionality that may be utilized by the fluorescence guided surgical imaging system 100.

In an exemplary embodiment, the computer control workstation 122 may control one or more operations of the fluorescence guided surgical imaging system 100. For example, the computer control workstation 122 may control the timing and operation of the fluorescence guided surgical imaging system 100, the types of data acquisition, and the data flow. The computer control workstation 122 may receive images from the visible image sensor 108 and the fluorescent image sensor 110 and process the images. For example, the computer control workstation 122 may process the images by down sampling (e.g., data compression) or up sampling (e.g., data expansion) the images. In an exemplary embodiment, the computer control workstation 122 may down-sample the images by down-sample coefficients in a range between 1-10 or other desired down-sample coefficient. Also, the computer control workstation 122 may process the images based at least in part on an optical magnification of the plurality of fixed magnification lenses (e.g., a first fixed magnification lens 134 and a second fixed magnification lens 136) of the imaging system 112.

In an exemplary embodiment, the images transmitted from the visible image sensor 108 and/or the fluorescent image sensor 110 to the computer control workstation 122 may have 1000×1000 pixels. The display device 140 may have a display region of 500×500 pixels. The images transmitted from the visible image sensor 108 and/or the fluorescent image sensor 110 may be processed by the computer control workstation 122. For example, the computer control workstation 122 may process (e.g., resize or crop) the input images transmitted from the visible image sensor 108 and/or the fluorescent image sensor 110 to a desired size of field of view. Also, the computer control workstation 122 may sample the input images and/or digitally interpolated the input images to output images to be displayed on the display device 140. An image (e.g., eliminating upsampling of images) may be provided to the surgeon via the display device 140 by combining the imaging system 112 and the processing of the images transmitted from the visible image sensor 108 and/or the fluorescent image sensor 110 by the computer control workstation 122.

For example, in a 1× optical magnification (e.g., field of view of 100×100 mm), the imaging system 112 may utilize a 1× fixed magnification lens (e.g., the first fixed magnification lens) to acquire input images to the computer control workstation 122. The input images transmitted by the 1× fixed magnification lens may acquire images of 1000×1000 pixels with 100×100 mm field of view. As discussed above, the display region of the display device 140 may be 500×500 pixels. The computer control workstation 122 may down-sample the input image by a down-sample coefficient of 2 to have an output image having 500×500 pixels to be displayed via the display device 140. For a field of view of 75×75 mm, the imaging system 112 may utilize a 1× fixed magnification lens (e.g., the first fixed magnification lens 134) to acquire an input image to the computer control workstation 122. As discussed above, the input image may acquire images of 1000×1000 pixels with 100×100 mm field of view. The computer control workstation 122 may process (e.g., by cropping and/or sampling) the input image. For example, the computer control workstation 122 may crop (e.g., by a field of view reduction coefficient of 0.75) the input video images of 1000×1000 pixels with 100×100 mm field of view to intermediate images of 750×750 pixels with 75×75 mm field of view. Subsequently, the computer control workstation 122 may down-sample the cropped input image (e.g., having images of 750×750 pixels) by a down-sample coefficient of 1.5 to have an output image having images of 500×500 pixels to be displayed by the display device 140. In a 2× optical magnification (e.g., field of view of 50×50 mm), the imaging system 112 may utilize a 1× fixed magnification lens (e.g., the first fixed magnification lens 134) to acquire input images to the computer control workstation 122. As discussed above, the input images may have images of 1000×1000 pixels with 100×100 mm field of view. The computer control workstation 122 may crop (e.g., by a field of view reduction coefficient of 0.5) the images of 1000×1000 pixels with 100×100 mm field of view to intermediate images of 500×500 pixels with 50×50 mm field of view. Thereafter, the computer control workstation 122 may not down-sample the cropped image having 500×500 pixels because the size of the cropped image may match the size of a display region of the display device 140. The computer control workstation 122 may directly display the cropped images (e.g., 500×500 pixels) via the display device 140.

In an exemplary embodiment, when small magnifications are required (e.g., 4×, 8× optical magnifications, etc), a second optical magnification lens, such as 2× fixed magnification lens, may be used in order to provide an image. For example, the 1× fixed magnification lens may acquire images of a field of view that may require upsampling of the acquired image. Thus, a second optical magnification lens may be configured to acquire images of a field of view that provide an image. In a 4× optical magnification (e.g., field of view of 25×25 mm), the imaging system 112 may utilize a second magnification lens (e.g., the second fixed magnification lens), such as a 2× fixed magnification lens, to acquire input images to the computer control workstation 122. The 2× fixed magnification lens may be used in order to acquire images (e.g., eliminate upsampling of input images) in accordance with the size of field of view to be displayed to the surgeon. For example, the input images acquired by the 2× fixed magnification lens may have images of 1000×1000 pixels with 25×25 mm field of view. The computer control workstation 122 may down-sample the input images by a down-sample coefficient of 2.0 to have an output image having 500×500 pixels to be displayed via the display device 140. In an 8× optical magnification (e.g., field of view of 12.5 mm), the imaging system 112 may utilize a 2× fixed magnification lens (e.g., the second fixed magnification lens 136) to acquire input images to the computer control workstation 122. As discussed above, the 2× fixed magnification lens may acquire an input image having images of 1000×1000 pixels with 25×25 mm field of view. The computer control workstation 122 may crop the images of 1000×1000 pixels with 25×25 mm field of view to intermediate images of 500×500 pixels with 12.5 mm field of view. Thereafter, the computer control workstation 122 may not down-sample the cropped image having 500×500 pixels because the size of the cropped image may match the size of a display region of the display device 140. The computer control workstation 122 may directly display the cropped images (e.g., 500×500 pixels) via the display device 140. It may be appreciated that additional fixed magnification lenses (e.g., 3× fixed magnification lens, 4× fixed magnification lens, 5× fixed magnification lens, etc) may be added to the imaging system 112 in order to achieve further magnifications of a field of view in accordance to a process discussed above. The combination of the imaging system 112 and digital processing by the computer control workstation 122 may provide chromatically corrected images over a wide spectral range and a geometric distortion less than 1%. Also, the combination of the imaging system 112 and the computer control workstation 122 may reduce the cost of the fluorescent guided surgical imaging system 100.

The computer control workstation 122 may include an image processing engine 126 (e.g., a software module that runs on the computer control workstation 122 and/or additional hardware) that may execute various image processing routines on the data acquired from the visible image sensor 108 and the fluorescent image sensor 110, such as those routines disclosed in the aforementioned U.S. Application Nos. 61/039,038 and 12/054,214. The image processing engine 126 may utilize a database 124 associated with the computer control workstation 122 for storing, among other things, image information and various computer programs for image processing. The database 124 may be provided in various forms, such as RAM, ROM, hard drive, flash drive, etc. The database 124 may comprise different components for different functions, such as a first component for storing computer programs, a second component for storing image information, etc. The image processing engine 126 may include hardware, software or a combination of hardware and software. The image processing engine 126 is programmed to execute various image processing methods. The methods typically involve acquiring frames of image information at different points in time. According to one embodiment, the frames of image information include image information from the visible optical spectral channel and image information from the fluorescent optical spectral channel. The image information sent from the visible optical spectral channel and the fluorescent optical spectral channel may be used to generate a merged image in which the image information from the fluorescent optical spectral channel is overlaid onto the image information from the visible optical spectral channel. The merged image may assist and guide the surgeon in visualizing certain tissues which emit fluorescent light during surgery.

While the foregoing description includes details and specific examples, it is to be understood that these have been included for purposes of explanation only, and are not to be interpreted as limitations of the present invention. For example, there are various types of image data and sensors that may be used in various embodiments of the present invention. In addition, although the above-described embodiments relate primarily to human surgical applications, exemplary embodiments of the present invention may be adapted for non-surgical, animal or other applications. Modifications to the embodiments described herein may be made without departing from the spirit and scope of the invention, which is intended to be encompassed by the following claims and their legal equivalents.

1. An imaging system comprising:
a visible light source configured to illuminate a surgical field with visible light;
an excitation source configured to generate excitation light to excite a fluorescent substance in an organism within the surgical field;
a first sensor configured to receive visible light reflected from the surgical field via a first spectral channel;
a second sensor configured to receive a fluorescent emission emitted from the fluorescent substance in the organism via a second spectral channel;
a plurality of fixed magnification lenses configured to optically couple image signals to the first sensor and the second sensor; and
a control unit configured to receive and digitally process the image signals to generate a plurality of image frames in order to rescale the plurality of image frames for display to a surgeon.

2. The system of claim 1, wherein the plurality of fixed magnification lenses is mounted on a motorized turret.

3. The system of claim 1, wherein the control unit is further configured to sample the image signals optically coupled by each of the plurality of fixed magnification lenses in order to generate the plurality of image frames.

4. The system of claim 3, wherein the control unit is configured to down-sample the image signals by a range of down-sample coefficient of 1-10.

5. The system of claim 1, wherein the control unit is further configured to digitally cropping the image signals optically coupled by each of the plurality of fixed magnification lenses in order to generate the plurality of image frames.

6. The system of claim 5, wherein the control unit digitally cropping the image signals optically coupled by each of the plurality of fixed magnification lenses is based at least in part on a size of field of view.

7. The system of claim 5, wherein the control unit digitally cropping the image signals optically coupled by each of the plurality of fixed magnification lenses by a range of a field of view coefficient of 0.1-1.

8. The system of claim 1, wherein each of the plurality of fixed magnification lenses is associated with disparate sizes of field of view.

9. The system of claim 1, further comprises a visible filter that blocks the excitation light from an excitation.

10. The system of claim 1, further comprises a fluorescent filter that blocks the visible light reflected from the organism.

11. The system of claim 1, further comprising a visible imaging optics system and a fluorescent imaging optics system.

12. The system of claim 11, wherein the visible imaging optics system comprises a visible filter and a visible relay lens.

13. The system of claim 11, wherein the fluorescent imaging optics system comprises a fluorescent filter and a fluorescent relay lens.

14. The system of claim 1, wherein the excitation light comprises near-infrared light or infrared light.

15. The system of claim 1, further comprising a motion controller coupled to the fixed magnification lens imaging system.

16. The system of claim 15, wherein the motion controller automatically controls the plurality of optical fix magnification lenses mounted on a motorized turret.

17. The system of claim 15, wherein the motion controller is coupled to the plurality of fixed magnification lenses via an actuator.

18. The system of claim 1, wherein the fixed magnification lens imaging system is configured for manual control.
